(19) United States
(12) Patent Application Publication
(10) Pub. No.: US 2008/0279385 A1
(43) Pub. Date: Nov. 13, 2008

(54) METHOD AND HOST DEVICE FOR USING CONTENT USING MOBILE CARD, AND MOBILE CARD

(75) Inventors: Ji-soon Park, Suwon-si (KR); Jun-bum Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/952,306

(22) Filed: Dec. 7, 2007

(30) Foreign Application Priority Data
May 10, 2007 (KR) 10-2007-0045426

(51) Int. Cl. H04L 9/08

(52) U.S. Cl. 380/278

(57) ABSTRACT

Provided are a method and host device for using content using a mobile card, and a mobile card. The method includes storing an identifier (ID) of the mobile card, a global key, and a content key encrypted by a secret key of the mobile card, generating a combined key of the ID and the global key, generating a first cryptogram, in which the content key encrypted by the secret key is encrypted by the combined key, transmitting the first cryptogram to the mobile card, receiving from the mobile card a second cryptogram, in which the content key is encrypted by the combined key, and decrypting the second cryptogram. Accordingly, a user can use encrypted content from a remote place.

### CROSS-REFERENCE TO RELATED PATENT APPLICATION

This application claims priority from Korean Patent Application No. 10-2007-0045426, filed on May 10, 2007, in the Korean Intellectual Property Office, the disclosure of which is incorporated herein in its entirety by reference.

### BACKGROUND OF THE INVENTION

1. Field of the Invention

The present invention relates to a method and host device for using content using a mobile card, and a mobile card, and more particularly, to a method and host device for using content which enables a user, who is in a remote place, to use encrypted content freely using a mobile card, and a mobile card.

2. Description of the Related Art

Recently, network technologies have developed, and thus the amount of content being shared through a network has increased. The concept of a home network, which enables electronic devices at home to share content by constructing a network at home, has expanded, and thus various methods of reproducing content of a user not only at home but also from a remote place are being suggested.

Methods of authenticating a user so that the user can use content from a remote place can be largely classified into a contact type and a non-contact type. In the contact type, such as a cable broadcast, a user is authenticated by inserting an authentication device, such as a smart card, into a host device. In the non-contact type, such as a near field communication (NFC) technology, a user is authenticated by using NFC near a host device that reproduces content.

FIG. 1 is a block diagram illustrating a related art mobile card 110 used for authentication by NFC.

Referring to FIG. 1, the mobile card 110 includes an interface 112, an internal central processing unit (CPU) 114, and an internal memory 116.

The internal CPU 114 controls overall operations of the mobile card 110. The internal memory 116 stores data (for example, user authentication information) required to operate the mobile card 110. The interface 112 enables the memory card 110 and a host device 100 to communicate. The host device 100 may be any device that can reproduce content.

The mobile card 110 may be formed so as not to expose internal data externally, and so that no device can access the internal memory 116 of the mobile card 110. Accordingly, internal data of the mobile card 110 cannot be cracked.

However, when a storage space of the internal memory 116 increases, a manufacturing cost and the size of the mobile card 110 increase. Accordingly, the internal memory 116 should have a minimum size. Also, weak operation capability and difficult power supply management of the mobile card 110 should be considered.

Consequently, a plan for minimizing the size of an operation code executed in the mobile code and the number of messages, while efficiently preventing secret information, such as a key transmitted/received between the host device 100 and the mobile card 110, from being exposed to a hacker is required.

### SUMMARY OF THE INVENTION

The present invention provides a method and host device for using content, in which encrypted content can be used from a remote place by using a mobile card, and a mobile card.

The present invention also provides a method and a host device for using content, in which the size of an operation code executed in a mobile card and the number of messages can be minimized while efficiently preventing secret information, such as a key, from being exposed to a hacker, and a mobile card.

According to an aspect of the present invention, there is provided a method of using content using a mobile card, the method including: storing an identifier (ID) of the mobile card, a global key, and a content key encrypted by a secret key of the mobile card; generating a combined key of the ID and the global key; generating a first cryptogram, in which the content key encrypted by the secret key is encrypted by the combined key; transmitting the first cryptogram to the mobile card; receiving a second cryptogram, in which the content key is encrypted by the combined key; and decrypting the second cryptogram.

The method may further include: storing content encrypted by the content key; and decrypting the content encrypted by the content key.

The method may further include receiving the encrypted content, the ID of the mobile card, and the content key encrypted by the secret key of the mobile card

The ID and the content key may be received in a form of metadata which is combined with the content.

In the generating of a combined key, the ID and the global key may be combined by an exclusive OR (XOR) operation.

The first cryptogram and the second cryptogram may be generated in such a way that the ID, divided into predetermined sizes, is inserted into each encrypting block.

The first cryptogram and the second cryptogram may include a random number encrypted by the combined key.

The first cryptogram and the second cryptogram may include the ID encrypted by the combined key.

According to another aspect of the present invention, there is provided a method of using content using a mobile card, the method including: storing an ID of the mobile card, a global key, and a secret key of the mobile card; receiving a first cryptogram, in which a content key, encrypted by the secret key, is encrypted by a combined key of the ID and the global key; generating the combined key and decrypting the first cryptogram; decrypting the content key, encrypted by the secret key; generating a second cryptogram, in which the content key is encrypted by the combined key; and transmitting the second cryptogram.

According to another aspect of the present invention, there is provided a host device for using content, including: a storage unit which stores an ID of a mobile card, a global key, and a content key encrypted by a secret key of the mobile card; a key generator which generates a combined key of the ID and the global key; an encryptor which generates a first cryptogram in which the content key, encrypted by a secret key of the mobile card, is encrypted by the combined key; a transmitter which transmits the first cryptogram to the mobile card; a first receiver which receives a second cryptogram, in which the content key is encrypted by the combined key; and a decryptor which decrypts the second cryptogram.

According to another aspect of the present invention, there is provided a mobile card for using content, including: a storage unit which stores an ID of the mobile card, a global key, and a secret key of the mobile card; a receiver which receives a first cryptogram, in which a content key, encrypted by the secret key, is encrypted by a combined key of the ID and the global key; a key generator which generates the combined key by receiving the ID and the global key from the storage unit; a decryptor which decrypts the first cryptogram and the content key, encrypted using the secret key; an encryptor which generates a second cryptogram, in which the content key is encrypted by the combined key; and a transmitter which transmits the second cryptogram.

According to another aspect of the present invention, there is provided a computer readable recording medium having recorded thereon a program for executing a method of using content using a mobile card, the method including: storing an ID of the mobile card, a global key, and a content key encrypted by a secret key of the mobile card; generating a combined key of the ID and the global key; generating a first cryptogram, in which the content key encrypted by the secret key is encrypted by the combined key; transmitting the first cryptogram to the mobile card; receiving a second cryptogram, in which the content key is encrypted by the combined key; and decrypting the second cryptogram.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a related art mobile card used for authentication by near field communication (NFC);

FIG. 2 is a diagram illustrating a system for using content according to an exemplary embodiment of the present invention;

FIG. 3 is a diagram illustrating a system for using content according to another exemplary embodiment of the present invention;

FIG. 4 illustrates a flowchart of a method of using content according to an exemplary embodiment of the present invention;

FIG. 5 illustrates a flowchart of a method of using content according to another exemplary embodiment of the present invention;

FIG. 6 illustrates a flowchart of a method of using content according to another exemplary embodiment of the present invention;

FIG. 7 illustrates a flowchart of a method of using content according to another exemplary embodiment of the present invention;

FIG. 8 is a diagram illustrating a host device according to an exemplary embodiment of the present invention; and

FIG. 9 is a diagram illustrating a mobile card according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

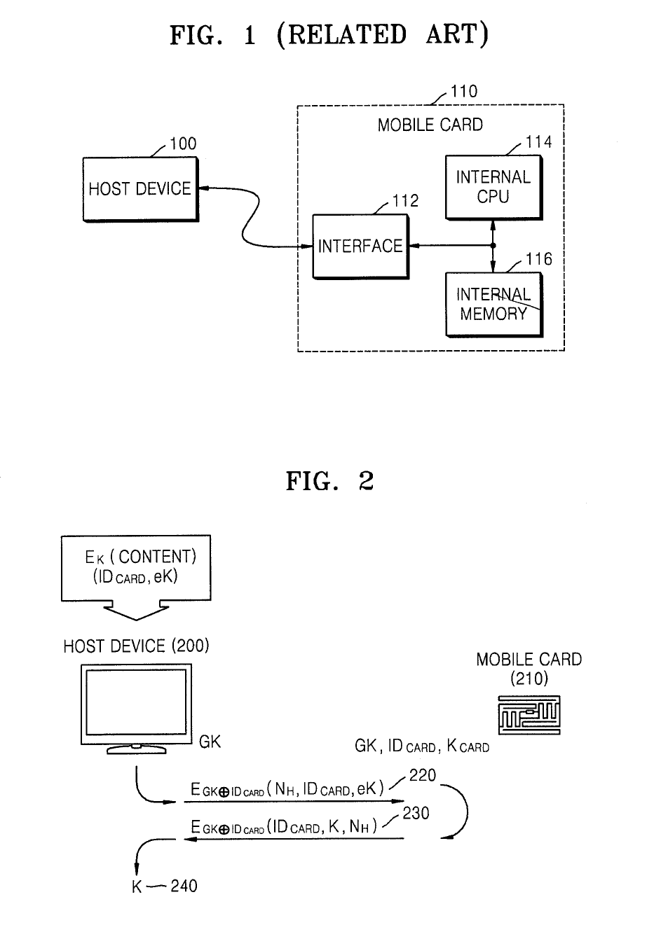

FIG. 2 is a diagram illustrating a system for using content according to an exemplary embodiment of the present invention.

Referring to FIG. 2, the system includes a host device 200 and a mobile card 210.

The host device 200 may be any device that can reproduce content. In the current exemplary embodiment, the host device 200 is located in a remote place away from home, but the location of the host device 200 is not limited thereto.

Generally, a host device at home has a content key that can reproduce encrypted content. Accordingly, a user does not need to use the separate mobile card 210 in order to reproduce the encrypted content, and can reproduce the encrypted content using the content key included in the host device at home.

However, the host device 200 in the remote place does not have a content key for reproducing encrypted content. Consequently, in order for a user to reproduce the encrypted content from a remote place, a means for receiving a content key is required. In the current exemplary embodiment the mobile card 210 is used as a medium for receiving a content key.

First the user can transmit encrypted content E_{K}(content), which is encrypted content stored at home via various methods including peer to peer (P2P), to the host device 200 in a remote place. At this time, an ID ID_{CARD} of the mobile card 210, and an encrypted content key eK (encrypted key), which is a content key encrypted by a secret key K_{CARD} of the mobile card 210, are transmitted with the encrypted content E_{K}(content) to the host device 200. The value of the ID ID_{CARD} of the mobile card 210 differs according to each user. Accordingly, when a user has a plurality of mobile cards 210 in the same place or a plurality of users has the same mobile card 210, only a user who has the same ID as the ID ID_{CARD} of the mobile card 210 transmitted to the host device 200 can reproduce content.

The host device 200 receives the encrypted content E_{K}(content), the ID ID_{CARD} of the mobile card 210, and the encrypted content key eK from the exterior. The ID ID_{CARD} of the mobile card 210 and the encrypted content key eK may be received in the form of metadata which is combined with the encrypted content E_{K}(content).

Upon receiving the encrypted content E_{K}(content), the ID ID_{CARD} of the mobile card 210, and the encrypted content key eK, the host device 200 stores the encrypted content E_{K}(content), the ID ID_{CARD} of the mobile card 210, and the encrypted content key eK. Also, the host device 200 stores a predetermined global key GK. The global key GK is a key set identically provided in an external content transmitter, the host device 200, and the mobile card 210, and is preset during production. Such a global key GK should not be open to the public.

The host device 200 combines the ID ID_{CARD} of the mobile card 210 and the global key GK by an exclusive OR (XOR) operation (that is, GK⊕ID_{CARD}), generates a random number N_{H}, and generates a first cryptogram, in which the random number N_{H}, the ID ID_{CARD} of the mobile card 210, and the encrypted content key eK are encrypted by GK⊕ID_{CARD}. The first cryptogram can be expressed as E_{GK⊕ID}_{_{CARD}} (N_{H}, ID_{CARD}, eK). Here, an advanced encryption standard (AES) algorithm may be used to generate the first cryptogram, but various algorithms can be used according to the situation. The host device 200 transmits the first cryptogram to the mobile card 210 in operation 220.

The mobile card 210 stores the ID ID_{CARD}, the global key GK, and the secret key K_{CARD}. The ID ID_{CARD}, the global key GK, and the secret key K_{CARD} are preset while manufacturing the mobile card 210.

The mobile card 210 receives the first cryptogram from the host device 200. GK⊕ID_{CARD} is generated using the ID ID_{CARD} and the global key GK stored in the mobile card 210, and the first cryptogram is decrypted by the GK⊕ID_{CARD}. When the first cryptogram is decrypted, the random number N_{H}, the ID ID_{CARD}, and the encrypted content key eK are acquired. Then, the content key eK is decrypted by the secret key K_{CARD} stored in the mobile card 210. Accordingly, a content key K is acquired.

The mobile card 210 generates a second cryptogram, in which the content key K is encrypted by GK⊕ID_{CARD}. The second cryptogram can be expressed as E_{GK⊕ID}_{_{CARD}} (ID_{CARD}, K, N_{H}). Also, an AES algorithm can be used to generate the second cryptogram, but the algorithm used is not limited thereto.

The mobile card 210 transmits the second cryptogram to the host device 200 in operation 230.

The host device 200 receives the second cryptogram from the mobile card 210. Then, the host device 200 acquires the content key K in operation 240 by decrypting the second cryptogram by GK⊕ID_{CARD}. The host device 200 decrypts the encrypted content E_{K}(content) by the content key K, and as a result can reproduce the decrypted content.

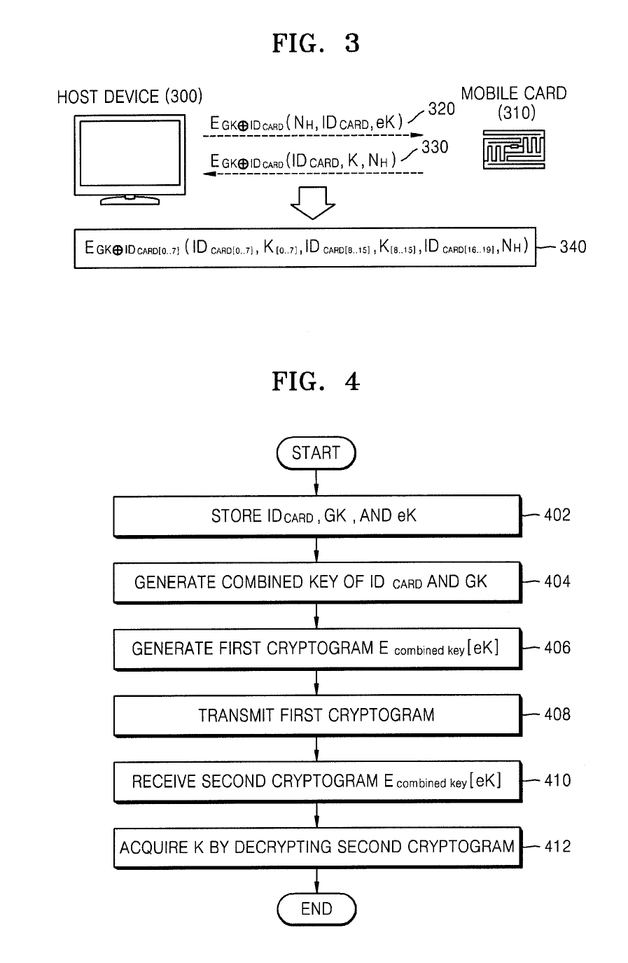

FIG. 3 is a diagram illustrating a system for using content according to another exemplary embodiment of the present invention.

Referring to FIG. 3, the system includes a host device 300 and a mobile card 310. The host device 300 and the mobile card 310 are similar to the host device 200 and the mobile card 210 described with reference to FIG. 2. However, a method of encrypting a random number N_{H}, an ID ID_{CARD} of the mobile card 310, and an encrypted content key eK, encrypted by a secret key of the mobile card 310, (that is, a method of generating a first cryptogram) used by the host device 300 is different from that of the host device 200. Also, a method of encrypting the random number N_{H}, the ID ID_{CARD} of the mobile card 310, and a content key K (that is, a method of generating a second cryptogram) used by the mobile card 310 is different from that of the mobile card 210.

For example, an AES algorithm can encrypt data in an encrypting block unit of 16 bytes. In this case, if a hacker alters any one of encrypting blocks including only the encrypted content key eK or the content key K, a user cannot reproduce content.

Accordingly in the current exemplary embodiment, the first and second cryptograms are generated in such a way that the ID ID_{CARD}, divided into a predetermined size, is inserted into each encrypting block. Referring to operation 330 of FIG. 3, ID_{CARD[0 . . . 7]} is inserted into a first encrypting block, ID_{CARD[8 . . . 15]} is inserted into a second encrypting block, and ID_{CARD[16 . . . 19]} is inserted into a third encrypting block. Bytes of the ID ID_{CARD} inserted into each encrypting block are preset in the host device 300 and the mobile card 310.

As described above, the host device 300 and the mobile card 310 can perform an integrity test on a received cryptogram message. In other words, the host device 300 and the mobile card 310 can check whether a hacker altered data by checking whether the ID ID_{CARD} is altered.

Accordingly, the host device 300 and the mobile card 310 can check whether the received cryptogram message is altered by dividing and inserting the ID ID_{CARD} so that a predetermined portion of the ID ID_{CARD} is inserted into all encrypting blocks in predetermined bytes (for example, 16 bytes) while generating the first and second cryptograms.

Alternatively, the first and second cryptograms may be generated by inserting predetermined data, instead of the ID ID_{CARD}, into each encrypting block.

FIG. 4 illustrates a flowchart of a method of using content according to an exemplary embodiment of the present invention.

Referring to FIG. 4, an ID ID_{CARD} of a mobile card, a global key GK, and an encrypted content key eK encrypted by a secret key of the mobile card are stored in operation 402.

In operation 404, a combined key of the ID ID_{CARD} and the global key GK is generated. The ID ID_{CARD} and the global key GK can be combined using various methods, such as an AND operation, OR operation, XOR operation, etc.

In operation 406, a first cryptogram, in which the encrypted content key eK is encrypted by the combined key, is generated. The first cryptogram can be generated using various methods, including an AES algorithm.

Alternatively, a first cryptogram, in which the encrypted content key eK is encrypted by the ID ID_{CARD}, can be generated. In this case, the global key GK is not required to be stored in operation 402, and operation 404 is not required.

In operation 408, the first cryptogram is transmitted to the mobile card.

In operation 410, a second cryptogram, in which a decrypted content key K is encrypted by the combined key, is received.

In operation 412, the content key K is acquired by decrypting the received second cryptogram. Alternatively, the content key K can be acquired by decrypting the second cryptogram by the ID ID_{CARD}.

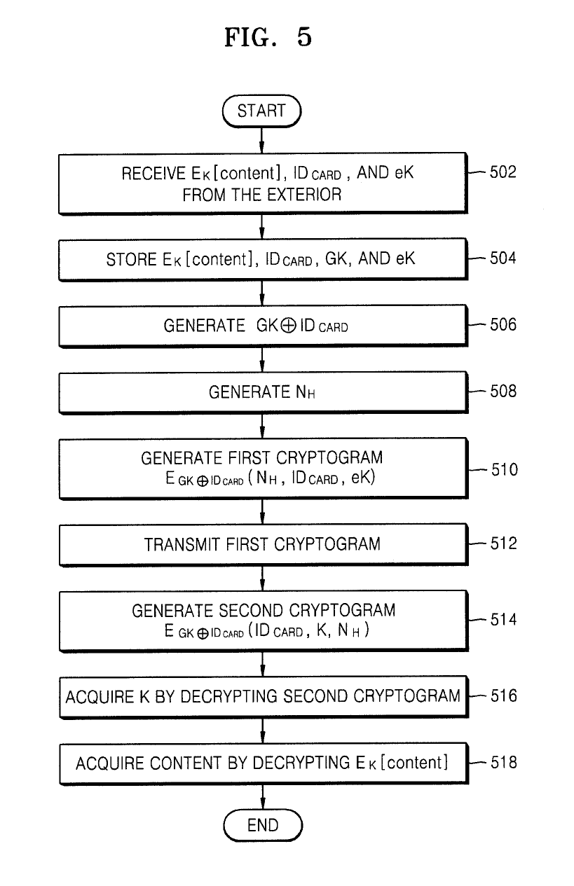

FIG. 5 illustrates a flowchart of a method of using content according to another exemplary embodiment of the present invention.

Referring to FIG. 5, in operation 502, encrypted content E_{K}(content), which is encrypted by a content key K, an ID ID_{CARD} of a mobile card, and an encrypted content key eK, which is encrypted by a secret key of the mobile card, are received from the exterior. Here, the ID ID_{CARD} of the mobile card may be randomly generated. This is to prevent the content key K from being exposed to a hacker, even if the hacker uses an unpredictable ID ID_{CARD} and thus exposing a global key GK to the hacker.

Also, the ID ID_{CARD} and the encrypted content key eK can be received in the form of metadata which is combined with the encrypted content E_{K}(content).

In operation 504, the global key GK, the encrypted content E_{K}(content), the ID ID_{CARD}, and the encrypted content key eK are stored.

In operation 506, a combined key, in which the global key GK and the ID ID_{CARD} are combined by an XOR operation, is generated.

In operation 508, a random number N_{H} is generated.

In operation 510, a first cryptogram E_{GK⊕ID}_{_{CARD}} (N_{H}, ID_{CARD}, eK), in which the random number N_{H}, the ID ID_{CARD}, and the encrypted content key eK are encrypted by GK⊕ID_{CARD}, is generated.

In operation 512, the first cryptogram is transmitted to the mobile card.

In operation 514, a second cryptogram E_{GK⊕ID}_{_{CARD}} (ID_{CARD}, K, N_{H}), in which the random number N_{H}, the ID ID_{CARD}, and the content key K are encrypted by GK ⊕ID_{CARD}, is received.

In operation 516, the content key K is acquired by decrypting the second cryptogram by GK⊕ID_{CARD.}

In operation 518, content is acquired by decrypting the encrypted content E_{K}(content) by the content key K.

In the current exemplary embodiment, the first and second cryptograms may be generated in such a way that the ID ID_{CARD}, divided into a predetermined size, is inserted into each encrypting block.

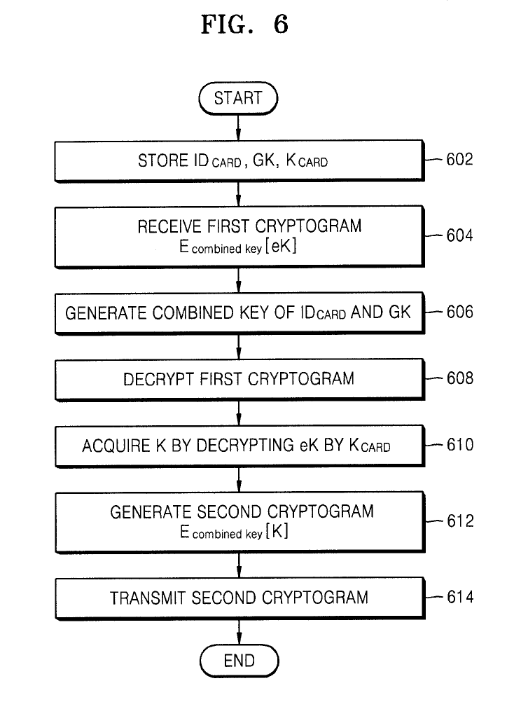

FIG. 6 illustrates a flowchart of a method of using content according to another exemplary embodiment of the present invention.

Referring to FIG. 6, an ID ID_{CARD}, of a mobile card, a global key GK, and a secret key K_{CARD} of the mobile card are stored in operation 602.

In operation 604, a first cryptogram, in which an encrypted content key eK, encrypted by the secret key K_{CARD}, is encrypted by a combined key of the ID ID_{CARD} and the global key GK, is received.

In operation 606, the combined key of the ID ID_{CARD} and the global key GK is generated.

In operation 608, the first cryptogram received in operation 604 is decrypted by the combined key generated in operation 606.

In operation 610, the encrypted content key eK is decrypted by the secret key K_{CARD}.

In operation 612, a second cryptogram, in which the decrypted content key K is encrypted by the combined key, is generated.

In operation 614, the second cryptogram is transmitted.

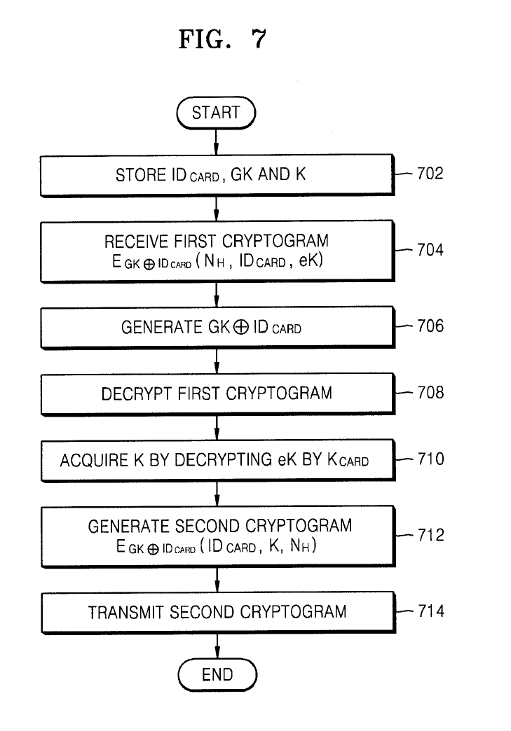

FIG. 7 illustrates a flowchart of a method of using content according to another exemplary embodiment of the present invention.

Referring to FIG. 7, the ID ID_{CARD} of a mobile card, a global key GK, and a secret key K_{CARD} of the mobile key are stored in operation 702. The ID ID_{CARD} may be randomly generated.

In operation 704, a first cryptogram in which an encrypted content key eK, encrypted by the secret key K_{CARD}, is encrypted by a combined key, in which the ID ID_{CARD} and the global key GK are combined by an XOR operation, is received. The first cryptogram and a second cryptogram, which will be describe later, may be generated in such a way that the ID ID_{CARD}, divided into a predetermined size, is inserted into each encrypting block.

In operation 706, the combined key, in which the ID ID_{CARD} and the global key GK are combined by an XOR operation, is generated.

In operation 708, the first cryptogram is decrypted.

In operation 710, the encrypted content key eK is decrypted.

In operation 712, the second cryptogram, in which the decrypted content key K is encrypted by the combined key, is generated.

In operation 714, the second cryptogram is transmitted.

Alternatively, a first cryptogram, in which the encrypted content key eK is encrypted by the ID ID_{CARD}, may be received. In this case, the global key GK is not required to be stored in operation 702, and operation 706 is not required.

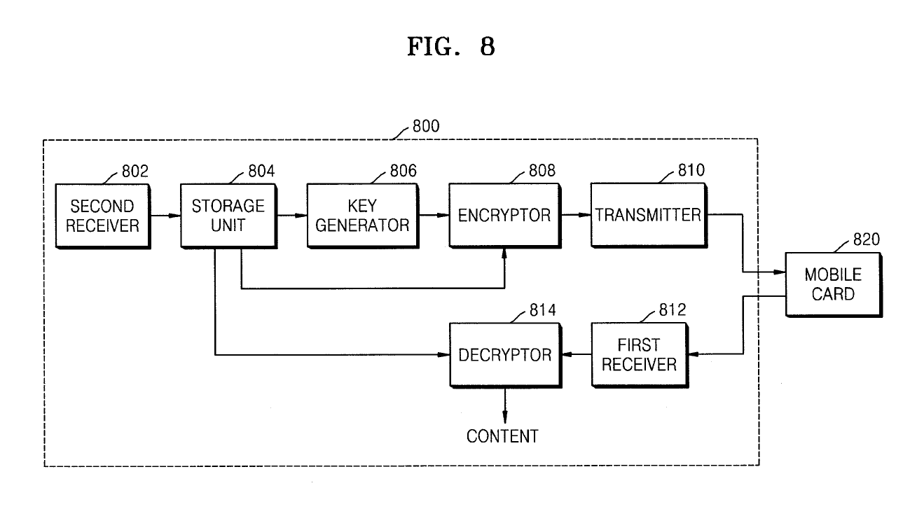

FIG. 8 is a diagram illustrating a host device 800 according to an exemplary embodiment of the present invention.

Referring to FIG. 8, the host device 800 includes a second receiver 802, a storage unit 804, a key generator 806, an encryptor 808, a transmitter 810, a first receiver 812, and a decryptor 814.

The second receiver 802 receives an encrypted content E_{K}(content), encrypted by a content key K, an ID ID_{CARD} of a mobile card 820, and an encrypted content key eK, encrypted by a secret key of the mobile card 820 from the exterior. The second receiver 802 may receive the ID ID_{CARD} and the encrypted content key eK in the form of metadata which is combined with the encrypted content E_{K}(content).

The storage unit 804 stores a global key GK, the ID ID_{CARD} and the encrypted content key eK. Also, the storage unit 804 stores the encrypted content E_{K}(content).

The key generator 806 generates a combined key of the ID ID_{CARD} and the global key GK. For example, the key generator 806 may generate the combined key in which the ID ID_{CARD} and the global key GK are combined by an XOR operation.

The encryptor 808 generates a first cryptogram, in which the encrypted content key eK is encrypted by the combined key (for example, GK⊕ID_{CARD}). The encrypted content key eK is received from the storage unit 804 and the combined key is received from the key generator 806. Also, a message encrypted by the encryptor 808 may include the ID ID_{CARD} or a random number N_{H}.

The transmitter 810 transmits the first cryptogram to the mobile card 820 wirelessly. Alternatively, the first cryptogram may be transmitted by wire.

The first receiver 812 receives a second cryptogram, in which the content key K, decrypted in the mobile card 820, is encrypted by the combined key.

The decryptor 814 acquires the content key K by decrypting the second cryptogram and decrypts the encrypted content E_{K}(content) by the content key K.

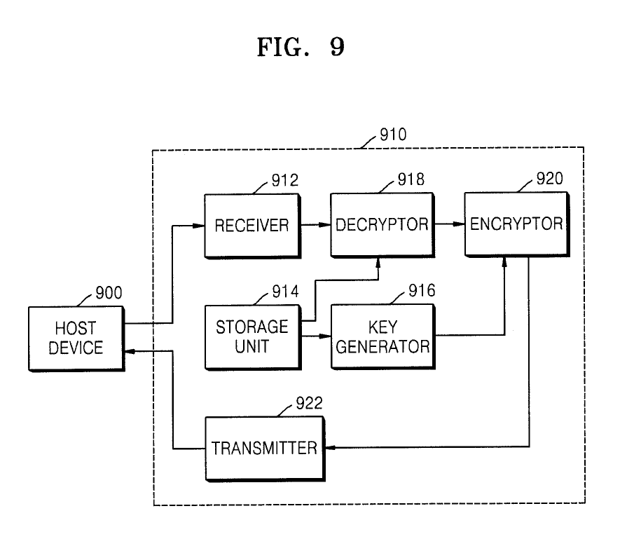

FIG. 9 is a diagram illustrating a mobile card 910 according to an exemplary embodiment of the present invention.

Referring to FIG. 9, the mobile card 910 includes a receiver 912, a storage unit 914, a key generator 916, a decryptor 918, an encryptor 920, and a transmitter 922.

The receiver 912 receives a first cryptogram, in which an encrypted content key eK, encrypted by a secret key K_{CARD} of the mobile card 910, is encrypted by a combined key of an ID ID_{CARD} of the mobile card 910 and a global key GK. Alternatively, a first cryptogram, in which the encrypted content key eK is encrypted by the ID ID_{CARD}, can be received.

The storage unit 914 stores the ID ID_{CARD}, the global key GK, and the secret key K_{CARD}.

The key generator 916 receives the ID ID_{CARD} and the global key GK from the storage unit 914 and generates the combined key. Preferably, but not necessarily, the key generator 916 combines the ID ID_{CARD} and the global key GK by an XOR operation.

The decryptor 918 decrypts the first cryptogram and the encrypted content key eK. As a result, the decryptor 918 outputs a content key K.

The encryptor 920 generates a second cryptogram, in which the content key K is encrypted by the combined key. Also, a message encrypted by the encryptor 920 may include the ID ID_{CARD} or a random number N_{H}.

The transmitter 922 wirelessly transmits the second cryptogram to a host device 900. Alternatively, the second cryptogram may be transmitted by wire.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, using the method and host device for using content using a mobile card, and a mobile card, the host device can acquire a content key by using a mobile card having a secret key that can induce the content key. Accordingly, a user can use encrypted content from a remote place.

Also, according to the method and host device for using content using a mobile card, and the mobile card, the size of an operation code executed in the mobile card and the number of messages can be minimized, and secret information can be efficiently prevented from being exposed to a hacker.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of using content using a mobile card, the method comprising:
storing an identifier (ID) of the mobile card, a global key, and a content key encrypted by a secret key of the mobile card;
generating a combined key of the ID and the global key;
generating a first cryptogram, in which the content key encrypted by the secret key is encrypted by the combined key;
transmitting the first cryptogram to the mobile card;
receiving from the mobile card a second cryptogram, in which the content key is encrypted by the combined key; and
decrypting the second cryptogram.

2. The method of claim 1, further comprising:
storing content encrypted by the content key; and
decrypting the content encrypted by the content key.

3. The method of claim 2, further comprising receiving the encrypted content, the ID of the mobile card, and the content key encrypted by the secret key of the mobile card.

4. The method of claim 3, wherein the ID and the content key are received in a form of metadata which is combined with the content.

5. The method of claim 1, wherein the generating the combined key comprises performing an exclusive OR operation on the ID and the global key.

6. The method of claim 1, wherein the first cryptogram and the second cryptogram comprise the ID encrypted by the combined key.

7. The method of claim 1, wherein the first cryptogram and the second cryptogram comprise a random number encrypted by the combined key.

8. The method of claim 6, wherein the first cryptogram and the second cryptogram are generated so that the ID, divided into predetermined sizes, is inserted into each encrypting block.

9. The method of claim 1, wherein the ID is randomly generated.

10. A method of using content using a mobile card, the method comprising:
storing an identifier (ID) of the mobile card, a global key, and a secret key of the mobile card;
receiving a first cryptogram, in which a content key, encrypted by the secret key, is encrypted by a combined key of the ID and the global key;
generating the combined key and decrypting the first cryptogram using the combined key;
decrypting the content key, encrypted by the secret key;
generating a second cryptogram, in which the content key is encrypted by the combined key; and
transmitting the second cryptogram.

11. The method of claim 10, wherein the generating the combined key comprises performing an exclusive OR operation on the ID and the global key.

12. The method of claim 10, wherein the first and second cryptograms comprise the ID encrypted by the combined key.

13. The method of claim 10, wherein the first and second cryptograms comprise a random number encrypted by the combined key.

14. The method of claim 12, wherein the first and second cryptograms are generated so that the ID, divided into predetermined sizes, is inserted into each encrypting block.

15. The method of claim 10, wherein the ID is randomly generated.

16. A host device for using content, the host device comprising:
a storage unit which stores an identifier (ID) of a mobile card, a global key, and a content key encrypted by a secret key of the mobile card;
a key generator which generates a combined key of the ID and the global key;
an encryptor which generates a first cryptogram in which the content key, encrypted by a secret key of the mobile card, is encrypted by the combined key;
a transmitter which transmits the first cryptogram to the mobile card;
a first receiver which receives from the mobile card a second cryptogram, in which the content key is encrypted by the combined key; and
a decryptor which decrypts the second cryptogram.

17. The host device of claim 16, wherein the storage unit stores content encrypted by the content key, and the decryptor decrypts the content encrypted by the content key.

18. The host device of claim 17, further comprising a second receiver which receives the content, encrypted by the content key, the ID of the mobile card, and the content key, encrypted by the secret key of the mobile card.

19. The host device of claim 18, wherein the second receiver receives the ID and the content key in a form of metadata which is combined with the content.

20. The host device of claim 16, wherein the key generator generates the combined key by performing an exclusive OR operation on the ID and the global key.

21. A mobile card for using content, the mobile card comprising:
a storage unit which stores an identifier (ID) of the mobile card, a global key, and a secret key of the mobile card;
a receiver which receives a first cryptogram, in which a content key, encrypted by the secret key, is encrypted by a combined key of the ID and the global key;
a key generator which generates the combined key based on the ID and the global key stored in the storage unit;
a decryptor which decrypts the first cryptogram and the content key, encrypted using the secret key;
an encryptor which generates a second cryptogram, in which the content key is encrypted by the combined key; and
a transmitter which transmits the second cryptogram.

22. The mobile card of claim 21, wherein the key generator generates the combined key by performing an exclusive OR operation on the ID and the global key.

23. The mobile card of claim 21, wherein the first and second cryptograms comprise the ID, encrypted by the combined key.

24. The mobile card of claim 21, wherein the first and second cryptograms comprise a random number encrypted by the combined key.

25. A computer readable recording medium having recorded thereon a program for executing a method of using content using a mobile card, the method comprising:
storing an identifier (ID) of the mobile card, a global key, and a content key encrypted by a secret key of the mobile card;
generating a combined key of the ID and the global key;
generating a first cryptogram, in which the content key encrypted by the secret key is encrypted by the combined key;
transmitting the first cryptogram to the mobile card;
receiving from the mobile card a second cryptogram, in which the content key is encrypted by the combined key; and
decrypting the second cryptogram.
